(19) United States
(12) Patent Application Publication
(10) Pub. No.: US 2007/0024641 A1
(43) Pub. Date: Feb. 1, 2007

(54) Picture signal processor and picture signal processing method

(75) Inventors: Hidetaka Nakamura, Ome-shi (JP); Akihiko Kubota, Ome-shi (JP); Masayoshi Sato, Ome-shi (JP); Hiroyuki Ishino, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/486,040

(22) Filed: Jul. 14, 2006

(30) Foreign Application Priority Data
Jul. 29, 2005 (JP) 2005-221963

(51) Int. Cl. G09G 5/00

(52) U.S. Cl. 345/620

(57) ABSTRACT

According to one embodiment, there are provided a clipping unit configured to clip out predetermined numbers of pixels respectively in the horizontal direction and the vertical direction from first and second solid-state image sensors which are installed so as be shifted by half a pixel pitch respectively in the horizontal direction and the vertical direction, and a processing unit configured to apply pixel shift processings in the horizontal direction and the vertical direction which correspond to pixel shifts of the first and second solid-state image sensors, with respect to an output of pixels clipped out by the clipping unit.

### CROSS-REFERENCE TO RELATED APPLICATIONS

This application is based upon and claims the benefit of priority from Japanese Patent Application No. 2005-221963, filed Jul. 29, 2005, the entire contents of which are incorporated herein by reference.

### BACKGROUND

1. Field

One embodiment of the invention particularly relates to a picture signal processor and a picture signal processing method suitable for use in 3CCD (charged coupled device) system color image pickup devices.

2. Description of the Related Art

As is commonly known, in recent years, so-called 3CCD system apparatuses have tended to be used not only for broadcasting stations but also for home use, as color image pickup devices. Such a 3CCD system apparatus images three primary colors of R (red), G (green), and B (blue) onto solid-state image sensors using CCDs or the like to be photoelectric-converted when an optical image of a photographed object is converted into an electronic signal.

Then, in color image pickup devices using the 3CCD system in this way, it has been considered that a resolution is improved by performing horizontal and vertical spatial pixel shifts in which respective solid-state image sensors onto which R light and B light are imaged are arranged so as to be shifted by half a pixel pitch respectively in the horizontal direction and the vertical direction from a solid-state image sensor onto which G light is imaged.

In this case, the solid-state image sensor onto which G light is imaged, and the respective solid-state image sensors onto which R light and B light are imaged are also electrically processed by shifts by half a pixel pitch respectively in the horizontal direction and the vertical direction, and processed by sampling at a frequency which is double a normal frequency respectively in the horizontal direction and the vertical direction. Consequently, an advantageous effect by spatial pixel shifts can be obtained. This means that a frequency of the sampling clock is made fourfold a normal frequency of the sampling clock.

In brief, assuming that a drive frequency of a solid-state image sensor in normal operation is fs, a drive frequency when spatial pixel shifts are performed in the horizontal direction and the vertical direction is made double (i.e., 2 fs) by sampling processing in the horizontal direction, and further made double (i.e., 4 fs) by sampling processing in the vertical direction. This means that signal processing must be performed at a frequency which is fourfold a normal frequency after the sampling processing in the horizontal direction.

For example, consideration will be given for a case in which an image output of 50 fps is obtained by using a solid-state image sensor whose horizontal direction valid pixels×vertical direction valid pixels are 1024×768. Assuming that a drive frequency in normal output is f, a frame period is as follows:
(1/50)=1024×768×(1/f),
which leads to drive frequency f=1024×768×50=39 MHz.

When spatial pixel shifts are performed in the horizontal direction and the vertical direction by using this solid-state image sensor, a drive frequency after sampling processings in the horizontal and vertical directions is made to be 39×4=156 MHz, and hereinafter, signal processing is performed at this frequency.

However, in general, integrated circuits (ICs) capable of performing signal processing at such a high frequency as 156 MHz are in small numbers extremely, which are high-priced, and it is hard to obtain those. Further, a high operating frequency brings about an increase in electric power consumption of necessity, which brings about problems in aspects of power supply and thermal design as well.

In Jpn. Pat. Appln. KOKAI Publication No. 2000-341708, there is disclosed a configuration of an image pickup device. The image pickup device obtains a sequentially operational picture signal (720 p) whose horizontal direction valid pixels×vertical direction valid pixels are 1280×720 in such a manner that spatial pixel shifts are performed in the horizontal direction and the vertical direction by using a solid-state image sensor whose horizontal direction valid pixels×vertical direction valid pixels are 640×480, the solid-state image sensor being compliant with VGA (video graphics array).

However, the Jpn. Pat. Appln. KOKAI Publication No. 2000-341708 merely disclosed that a sequentially operational system picture signal whose horizontal direction valid pixels×vertical direction valid pixels are 1280×720 is obtained by performing spatial pixel shifts in the horizontal direction and the vertical direction such that ¾ of the vertical direction valid pixels are fetched out of a progressive scanning system solid-state image sensor compliant with VGA. There is no description that a picture signal compliant with various systems is obtained.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows one embodiment of the invention, and is a block diagram shown for explaining a picture signal processing system of a color image pickup device;

FIGS. 2A and 2B are views shown for explaining one example of processing operations of a clipping unit of the color image pickup device in the embodiment;

FIG. 3 is a block diagram shown for explaining details of the clipping unit in the embodiment;

FIGS. 4A and 4B are views shown for explaining another example of processing operations of the clipping unit of the color image pickup device in the embodiment; and

FIG. 5 is a flowchart shown for explaining processing operations of the color image pickup device in the embodiment.

### DETAILED DESCRIPTION

Various embodiments according to the invention will be described hereinafter with reference to the accompanying drawings. In general, according to one embodiment of the invention, there are provided a clipping unit configured to clip out predetermined numbers of pixels respectively in the horizontal direction and the vertical direction from first and second solid-state image sensors which are installed so as be shifted by half a pixel pitch respectively in the horizontal direction and the vertical direction, and a processing unit configured to apply pixel shift processings in the horizontal direction and the vertical direction which correspond to pixel shifts of the first and second solid-state image sensors, with respect to an output of pixels clipped out by the clipping unit.

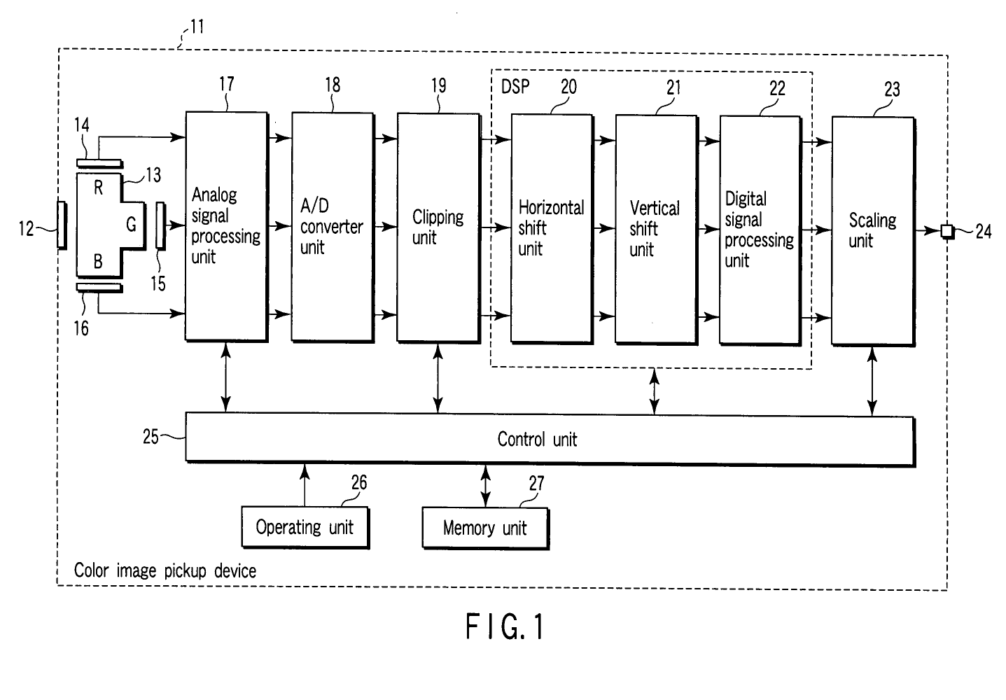

FIG. 1 shows a picture signal processing system of a color image pickup device 11 which will be described in this embodiment. Namely, an optical image of an object incident via an image pickup lens 12 is supplied to a spectroscopic prism 13, and is separated into primary colors of R, G and B.

Then, optical images of the respective primary colors R, G and B separated by the spectroscopic prism 13 are imaged onto solid-state image sensors 14, 15 and 16 installed so as to correspond to the respective primary colors R, G and B, and are converted into electronic signals corresponding to the optical images.

Thereafter, the R, G and B signals output from the respective solid-state image sensors 14 to 16 are digitized in an analog/digital (A/D) converter 18 via an analog signal processing unit 17 to be supplied to a clipping unit 19.

Although the details thereof will be described later, the clipping unit 19 is configured as follows. That is, when valid pixels after pixel shift processings in the horizontal direction and the vertical direction are greater than a finally-needed number of pixels, a necessary number of pixels, i.e., only pixels in the number from which a finally-needed number of pixels can be obtained are clipped out by pixel shift processings in the horizontal direction and the vertical direction from the solid-state image sensors 14 to 16. Then, an output of the clipped pixels is supplied to pixel shift processing in the horizontal direction and pixel shift processing in the vertical direction at a subsequent stage.

The R, G and B signals from which necessary pixels have been clipped out in the clipping unit 19 are supplied to a horizontal shift unit 20 to be subjected to pixel shift processing in the horizontal direction. Subsequently, the signals are supplied to a vertical shift unit 21 to be subjected to pixel shift processing in the vertical direction. Thereafter, the signals are supplied to a digital signal processing unit 22 to be subjected to predetermined digital signal processing. Note that, the above-described horizontal shift unit 20, vertical shift unit 21, and digital signal processing unit 22 are composed as a digital signal processor (DSP).

Thereafter, the R, G and B signals output from the digital signal processing unit 22 are supplied to a scaling unit 23 to be subjected to predetermined scaling processing, and then, the signals are derived to the outside via an output terminal 24.

Here, all operations of the color image pickup device 11, including the various image pickup operations described above, are overall controlled by a control unit 25. The control unit 25 incorporates a central processing unit (CPU) and the like, and receives operation information from an operating unit 26 to thereby control the respective units such that the operation contents thereof are reflected.

In this case, the control unit 25 utilizes a memory unit 27. The memory unit 27 mainly includes a read only memory (ROM) having stored therein a control program executed by the CPU, a random access memory (RAM) which provides a work area to the CPU, and a nonvolatile memory in which various setting information and control information, etc. are stored.

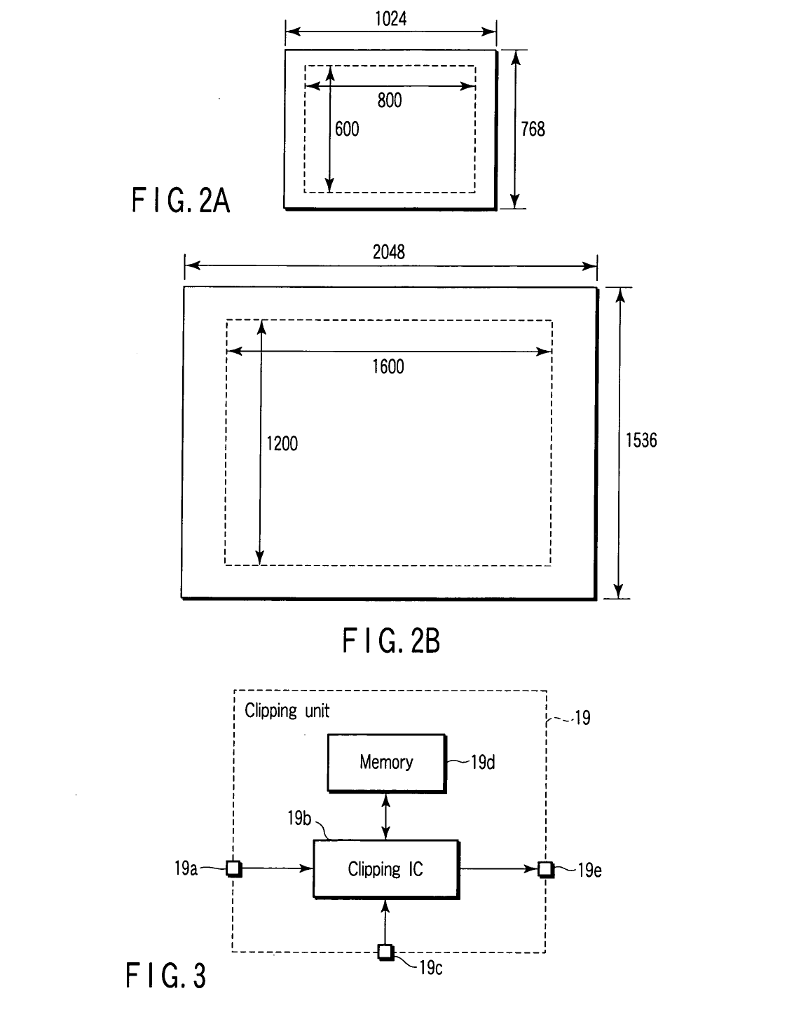

Here, it is assumed that, as shown by the solid line in FIG. 2A, the solid-state image sensors 14 to 16 are compliant with XGA (extended graphics array), whose horizontal direction valid pixels×vertical direction valid pixels are 1024×768. When an attempt is made to obtain an image output of 50 fps by using the solid-state image sensors 14 to 16, the drive frequency f is made to be 39 MHz as described above.

Then, spatial pixel shift processings in the horizontal direction and the vertical direction are performed by using the solid-state image sensors 14 to 16. In this case, with respect to an image after the pixel shift processings, horizontal direction valid pixels×vertical direction valid pixels are made to be 2048×1536 which are respectively double, as shown by the solid line in FIG. 2B. When an attempt is made to obtain an image output of 50 fps, the drive frequency f is made to be 156 MHz which is fourfold.

In contrast thereto, it is assumed that a finally-needed image is, as shown by the dotted line in FIG. 2B, an image whose horizontal direction valid pixels×vertical direction valid pixels are 1600×1200, the image being compliant with UXGA.

In this way, when the valid pixels 2048×1536 after performing spatial pixel shift processings in the horizontal direction and the vertical direction onto the solid-state image sensors 14 to 16 are greater than the valid pixels 1600×1200 of a finally-needed image, the control unit 25 provides the following clipping instruction to the clipping unit 19.

More specifically, as shown by the dotted line in FIG. 2A, the control unit 25 instructs the clipping unit 19 to clip out 800 pixels which are half the horizontal direction valid pixels 1600 of a finally-needed image in the horizontal direction, and to clip out 600 pixels which are half the vertical direction valid pixels 1200 of a finally-needed image in the vertical direction.

As a consequence, with respect to a clipped image whose horizontal direction valid pixels×vertical direction valid pixels are 800×600, the finally-needed horizontal direction valid pixels 1600 can be obtained by performing pixel shift processing in the horizontal direction in the horizontal shift unit 20. In addition, the finally-needed vertical direction valid pixels 1200 can be obtained by performing pixel shift processing in the vertical direction in the vertical shift unit 21.

In this way, when an attempt is made to obtain an image output of 50 fps with respect to an image clipped such that horizontal direction valid pixels×vertical direction valid pixels are 800×600, a drive frequency f in normal output is made to be f=800×600×50=24 MHz.

Then, when spatial pixel shift processings are respectively performed in the horizontal direction and the vertical direction by using the clipped image, a drive frequency after the pixel shift processings is made fourfold the drive frequency f in normal output, i.e., to be 24×4=96 MHz, and can be made lower than the drive frequency 156 MHz described above.

FIG. 3 shows details of the clipping unit 19. Namely, the R, G and B signals (whose valid pixels are 1024×768, and whose drive frequencies are 39 MHz) output from the A/D converter 18 are supplied to a clipping IC 19b via an input terminal 19a.

The clipping IC 19b clips out R, G and B signals whose valid pixels are 800×600, and whose drive frequencies are 24 MHz by use of a memory 19d for accumulating pixels corresponding to a frame on the basis of a clipping instruction requested via a control terminal 19c from the control unit 25. Then, the clipping IC 19b outputs the signals to the horizontal shift unit 20 via an output terminal 19e.

In this case, as the clipping IC 19b, for example, a general-purpose scaler IC satisfying valid pixels for input/output, a programmable logic device (PLD), or the like can be used.

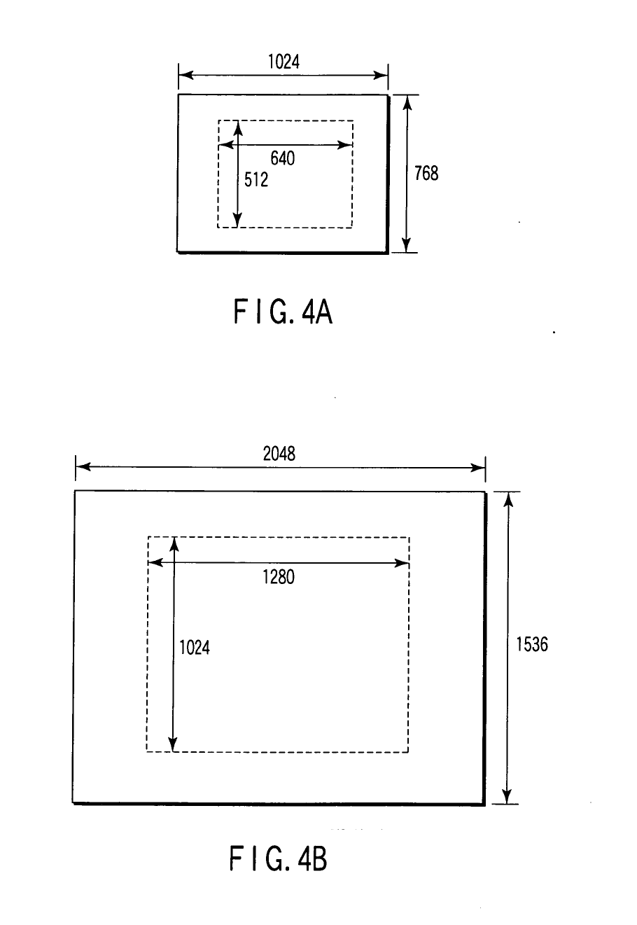

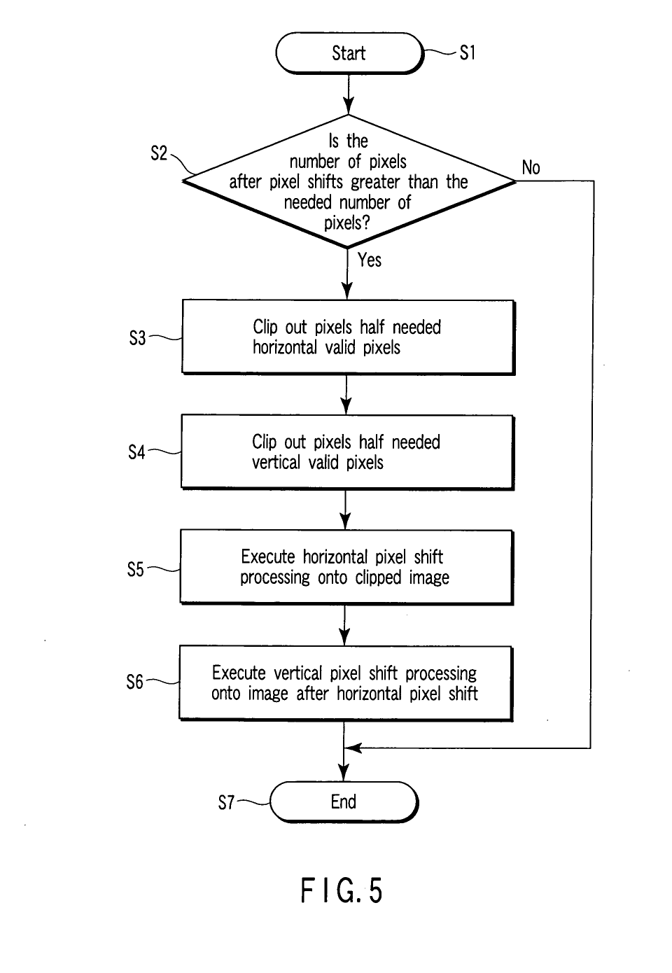

FIG. 4 shows another example of clipping. When the solid-state image sensors 14 to 16 are, as shown by the solid line in FIG. 4A, are compliant with XGA, whose horizontal direction valid pixels×vertical direction valid pixels are 1024×768, a drive frequency f when an attempt is made to obtain an image output of 50 fps by using the solid-state image sensors 14 to 16 is made to be 39 MHz, as described above.

Then, spatial pixel shift processings in the horizontal direction and the vertical direction are performed by using the solid-state image sensors 14 to 16. In this case, with respect to an image after the pixel shift processings, horizontal direction valid pixels×vertical direction valid pixels are made to be 2048×1536 which are respectively double, as shown by the solid line in FIG. 4B. When an attempt is made to obtain an image output of 50 fps, the drive frequency f is made to be 156 MHz which is fourfold.

In contrast thereto, it is assumed that a finally-needed image is, as shown by the dotted line in FIG. 4B, an image whose horizontal direction valid pixels×vertical direction valid pixels are 1280×1024, the image being compliant with SXGA.

In this way, when the valid pixels 2048×1536 after performing spatial pixel shift processings in the horizontal direction and the vertical direction onto the solid-state image sensors 14 to 16 are greater than the valid pixels 1280×1024 of a finally-needed image, the control unit 25 provides the following clipping instruction to the clipping unit 19.

More specifically, as shown by the dotted line in FIG. 4A, the control unit 25 instructs the clipping unit 19 to clip out 640 pixels which are half the horizontal direction valid pixels 1280 of a finally-needed image in the horizontal direction, and to clip out 512 pixels which are half the vertical direction valid pixels 1024 of a finally-needed image in the vertical direction.

As a consequence, with respect to a clipped image whose horizontal direction valid pixels×vertical direction valid pixels are 640×512, the finally-needed horizontal direction valid pixels 1280 can be obtained by performing pixel shift processing in the horizontal direction in the horizontal shift unit 20. In addition, the finally-needed vertical direction valid pixels 1024 can be obtained by performing pixel shift processing in the vertical direction in the vertical shift unit 21.

In this way, when an attempt is made to obtain an image output of 50 fps with respect to an image clipped such that horizontal direction valid pixels×vertical direction valid pixels are 640×512, a drive frequency f in normal output is made to be f=640×512×50=16 MHz.

Then, when spatial pixel shift processings are respectively performed in the horizontal direction and the vertical direction by using the clipped image, a drive frequency after the pixel shift processings is made fourfold the drive frequency f in normal output, i.e., to be 16×4=65 MHz, and can be made lower than the drive frequency 156 MHz described above.

FIG. 5 shows a flowchart in which the clipping operations described above are summarized. Namely, when the processing is started (block S1), the control unit 25 determines in block S2 whether or not valid pixels after spatial pixel shift processings in the horizontal direction and the vertical direction onto the solid-state image sensors 14 to 16 are greater than the number of pixels of a finally-needed image. When it is determined that valid pixels after spatial pixel shift processings are not larger than the number of pixels of a finally-needed image (NO), the control unit 25 terminates the processing (block S7).

Further, when it is determined that valid pixels after spatial pixel shift processings are greater than the number of pixels of a finally-needed image (YES) in the block S2, the control unit 25 instructs the clipping unit 19 to clip out pixels which are half the finally-needed horizontal direction valid pixels in the horizontal direction from the solid-state image sensors 14 to 16 in block S3.

Thereafter, in block S4, the control unit 25 instructs the clipping unit 19 to clip out pixels which are half the finally-needed vertical direction valid pixels in the vertical direction from the solid-state image sensors 14 to 16.

In block S5, the control unit 25 controls the horizontal shift unit 20 to carry out spatial pixel shift processing in the horizontal direction onto a clipped image. Then, in block S6, the control unit 25 controls the vertical shift unit 21 to carry out spatial pixel shift processing in the vertical direction onto the image after the horizontal pixel shift processing, and terminates the processing (block S7).

In accordance with the embodiment described above, when valid pixels after pixel shift processings in the horizontal direction and the vertical direction are greater than a finally-needed number of pixels, pixels which are half the finally-needed horizontal and vertical valid pixels are clipped out of the solid-state image sensors 14 to 16, and are supplied for pixel shift processings in the horizontal direction and the vertical direction at a subsequent stage. As a consequence, a drive frequency after pixel shift processings in the horizontal direction and the vertical direction can be suppressed low, and additionally, picture signals compliant with various systems (UXGA, SXGA) can be obtained. Because a drive frequency can be made to be a low frequency, a general-purpose signal processing IC can be used, which makes it possible to achieve low-power consumption.

Further, in the embodiment described above, it has been described that pixel shifts in the horizontal direction and the vertical direction are performed by a 3CCD system color image pickup device. However, the invention can be applied to a 2CCD system or 4CCD system color image pickup device as well.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A picture signal processor comprising:
a first solid-state image sensor which has predetermined numbers of pixels respectively in the horizontal direction and the vertical direction, the first solid-state image sensor being configured to output an electronic signal corresponding to an optical image of a first color component due to the optical image being imaged;
a second solid-state image sensor which has pixels of the same numbers as those of the first solid-state image sensor respectively in the horizontal direction and the vertical direction, the second solid-state image sensor being installed so as be shifted by half a pixel pitch respectively in the horizontal direction and the vertical direction from the first solid-state image sensor, and being configured to output an electronic signal corresponding to an optical image of a second color component due to the optical image being imaged;
a clipping unit configured to respectively clip out predetermined numbers of pixels in the horizontal direction and the vertical direction from the first and second solid-state image sensors; and
a processing unit configured to apply pixel shift processings in the horizontal direction and the vertical direction which correspond to pixel shifts of the first and second solid-state image sensors, with respect to an output of pixels clipped out by the clipping unit.

2. A picture signal processor according to claim 1, wherein
the clipping unit is configured to clip out predetermined numbers of pixels respectively in the horizontal direction and the vertical direction from the first and second solid-state image sensors when numbers of pixels in the horizontal direction and the vertical direction after pixel shift processings by the processing unit are greater than finally-needed numbers of pixels in the horizontal direction and the vertical direction.

3. A picture signal processor according to claim 2, wherein
the clipping unit is configured to clip out pixels of the number from which finally-needed numbers of pixels in the horizontal direction and the vertical direction are obtained, respectively in the horizontal direction and the vertical direction from the first and second solid-state image sensors by performing pixel shift processings in the horizontal direction and the vertical direction by the processing unit.

4. A picture signal processor according to claim 3, wherein
the clipping unit is configured to clip out pixels of the number which is half the finally-needed numbers of pixels in the horizontal direction and the vertical direction, respectively in the horizontal direction and the vertical direction from the first and second solid-state image sensors.

5. A picture signal processor according to claim 4, wherein
the clipping unit is configured to clip out 800 pixels in the horizontal direction and clip out 600 pixels in the vertical direction from the first and second solid-state image sensors, when the horizontal direction number of pixels×the vertical direction number of pixels of each of the first and second solid-state image sensors are 1024×768, and the finally-needed horizontal direction number of pixels×the finally-needed vertical direction number of pixels are 1600×1200.

6. A picture signal processor according to claim 4, wherein
the clipping unit is configured to clip out 640 pixels in the horizontal direction and clip out 512 pixels in the vertical direction from the first and second solid-state image sensors, when the horizontal direction number of pixels×the vertical direction number of pixels of each of the first and second solid-state image sensors are 1024×768, and the finally-needed horizontal direction number of pixels×the finally needed vertical direction number of pixels are 1280×1024.

7. A picture signal processing method for an apparatus comprising:
a first solid-state image sensor which has predetermined numbers of pixels respectively in the horizontal direction and the vertical direction, and the first solid-state image sensor being configured to output an electronic signal corresponding to an optical image of a first color component due to the optical image being imaged, and
a second solid-state image sensor which has pixels of the same numbers as those of the first solid-state image sensor respectively in the horizontal direction and the vertical direction, the second solid-state image sensor being installed so as be shifted by half a pixel pitch respectively in the horizontal direction and the vertical direction from the first solid-state image sensor, and being configured to output an electronic signal corresponding to an optical image of a second color component due to the optical image being imaged,
the method comprising:
a first process of clipping out predetermined numbers of pixels respectively in the horizontal direction and the vertical direction from the first and second solid-state image sensors; and
a second block of applying pixel shift processings in the horizontal direction and the vertical direction which correspond to pixel shifts of the first and second solid-state image sensors, with respect to an output of pixels clipped out in the first block.

8. A picture signal processing method according to claim 7, wherein
the first block clips out predetermined numbers of pixels respectively in the horizontal direction and the vertical direction from the first and second solid-state image sensors, when numbers of pixels in the horizontal direction and the vertical direction after pixel shift processings in the second block are greater than finally-needed numbers of pixels in the horizontal direction and the vertical direction.

9. A picture signal processing method according to claim 8, wherein
the first block clips out pixels of the number from which finally-needed numbers of pixels in the horizontal direction and the vertical direction are obtained, respectively in the horizontal direction and the vertical direction from the first and second solid-state image sensors by performing pixel shift processings in the horizontal direction and the vertical direction in the second block.

10. A picture signal processing method according to claim 9, wherein
the first block clips out pixels of the number which is half the finally-needed numbers of pixels in the horizontal direction and the vertical direction, respectively in the horizontal direction and the vertical direction from the first and second solid-state image sensors.

11. A picture signal processing method according to claim 10, wherein
the first block clips out 800 pixels in the horizontal direction and clips out 600 pixels in the vertical direction from the first and second solid-state image sensors, when the horizontal direction number of pixels×the vertical direction number of pixels of each of the first and second solid-state image sensors are 1024×768, and the finally-needed horizontal direction number of pixels×the finally-needed vertical direction number of pixels are 1600×1200.

12. A picture signal processing method according to claim 10, wherein
the first block clips out 640 pixels in the horizontal direction, and clip outs 512 pixels in the vertical direction from the first and second solid-state image sensors, when the horizontal direction number of pixels×the vertical direction number of pixels of each of the first and second solid-state image sensors are 1024×768, and the finally-needed horizontal direction number of pixels×the finally-needed vertical direction number of pixels are 1280×1024.
